(19) United States
(12) Patent Application Publication
(10) Pub. No.: US 2025/0051194 A1
(43) Pub. Date: Feb. 13, 2025

(54) Nickel-Iron-Based Alloys for Electrochemical Reduction of Selenium Oxyanions

(71) Applicant: The Regents of the University of California, Oakland, CA (US)

(72) Inventors: Wei Tong, Albany, CA (US); Shengcun Ma, Fremont, CA (US)

(21) Appl. No.: 18/797,736

(22) Filed: Aug. 8, 2024

Related U.S. Application Data
(60) Provisional application No. 63/518,501, filed on Aug. 9, 2023.

(51) Int. Cl. C02F 1/461; B82Y 30/00; B82Y 40/00; C02F 101/10; C02F 103/10; C02F 103/34; C22C 38/08

(52) U.S. Cl. CPC C02F 1/46109; C22C 38/08; B82Y 30/00; B82Y 40/00; C02F 2001/46133; C02F 2001/46152; C02F 2101/106; C02F 2103/10; C02F 2103/34; C02F 2201/461; C02F 2305/08

(57) ABSTRACT

This disclosure provides systems, methods, and apparatus related to selenium removal from water. In one aspect, a method includes providing a device, the device including a cathode and an anode. The cathode comprises a nickel-iron-based alloy. With both the cathode and the anode in contact with water, a potential is applied between the cathode and the anode to reduce selenium that is within the water.

### RELATED APPLICATIONS

This application claims priority to U.S. Provisional Patent Application No. 63/518,501, filed Aug. 9, 2023, which is herein incorporated by reference.

### STATEMENT OF GOVERNMENT SUPPORT

This invention was made with government support under Contract No. DE-AC02-05CH11231 awarded by the U.S. Department of Energy, with support from the U.S. Department of Energy under Contract No. 4600014330, and with support from the State of California under Contract No. 4600014330. Both the Government and the Sponsor have certain rights in this invention.

### BACKGROUND

Selenium (Se) pollution in water sources is a global concern and has been documented worldwide. Se pollution in water is often the result of Se-laden wastewater from power plants and mining operations being discharged into natural water bodies. Recent examples in the news include Se pollutants from oil refineries in Los Angeles and the San Francisco Bay Area and from coal mines in Canada.

Selenium pollution has detrimental effects on aquatic ecosystems and wildlife, leading to deformities and reproductive issues in fish and other aquatic organisms. Excessive human and animal Se intake is toxic. To address this, the United States Environmental Protection Agency's (USEPA) maximum contaminant level (MCL) of Se in drinking water is now 0.05 milligrams per liter (mg/L). The USEPA currently identifies biological treatment as the best available technology to remove Se from wastewater, but it is expensive, produces non-biodegradable sludges, has a large carbon footprint, and is sensitive to chemical and environmental limitations.

An alternative—direct electrochemical reduction—offers multiple advantages: (i) high selectivity with fewer undesired reactions, (ii) no addition of chemicals and reduced energy consumption, (iii) continuous removal with convenient electrode regeneration, (iv) negligible sludge generation and management, and (v) potential Se recovery for reuse. This approach has been demonstrated using a gold (Au) electrode. Gold's high cost prohibits its widespread application, however. To address the cost limitation, studies have been performed on less expensive transition metal-based and carbon-based electrodes (e.g., graphite). However, the metal-based electrodes show a tendency for metal dissolution after the electro-reduction, and graphite electrodes fail to achieve the stringent Se regulation limit.

### SUMMARY

Described herein are nickel-iron (Ni—Fe)-based alloys that can effectively remove high-valence selenium pollutants (e.g., selenite [Se(IV), SeO₃²⁻] and selenate [Se(VI)], SeO₄²⁻) in an aqueous environment.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration of an electrochemical reduction system for Se(IV) removal in wastewater using a Ni—Fe electrode.

FIGS. 2A-2D show the performance of a Ni—Fe electrode for Se(IV) reduction. FIG. 2A shows cyclic voltammetry profiles, FIG. 2B shows Se(IV) removal rate, FIG. 2C shows Faraday efficiency, and FIG. 2D show specific energy consumption of various electrodes. The initial Se(IV) concentration was 1 mM and applied potential was −0.65 V vs. Ag/AgCl.

FIGS. 3A-3C show the aqueous stability of a Ni—Fe electrode. FIG. 3A shows metal dissolution of various electrodes after electro-reduction. Electrochemical surface area characterization of Fe (FIG. 3B) and Ni—Fe (FIG. 3C) electrodes is also shown, indicated by the slope between the current density and the scan rate from cyclic voltammetry measurements.

FIGS. 4A-4D show the performance of a Ni—Fe electrode for Se(IV) reduction under representative wastewater conditions. FIG. 4A shows Se(IV) removal rate, FIG. 4B shows Faraday efficiency of a Ni—Fe at elevated solution temperatures, FIG. 4C shows Se(IV) removal rate, and FIG. 4D shows Faraday efficiency of a Ni—Fe electrode in the presence of competing anions.

FIGS. 5A-5D show the performance of Ni—Fe-based electrodes for Se(IV) reduction.

FIG. 6 shows an example of a flow diagram illustrating a process for removing selenium from water.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

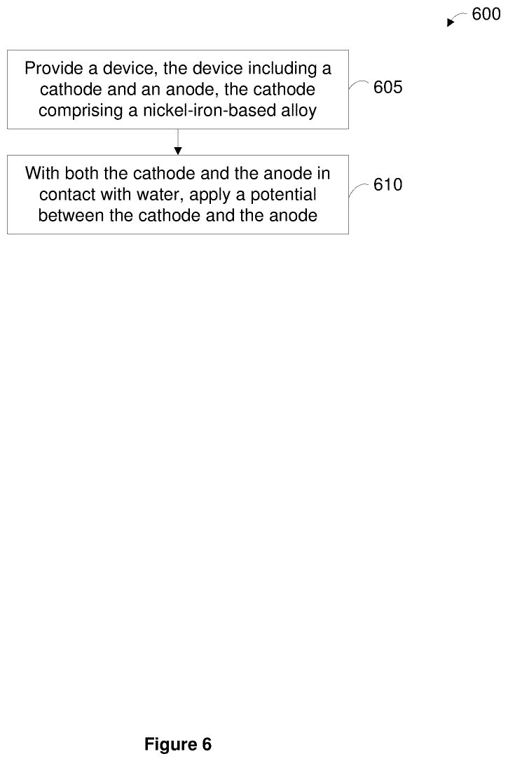

FIG. 6 shows an example of a flow diagram illustrating a process for removing selenium from water. Starting at block 605 of the method 600 shown in FIG. 6, a device including a cathode and an anode is provided. The cathode comprises a nickel-iron-based alloy.

In some embodiments, the cathode is a nickel-iron-based alloy. For example, the cathode may be a block, sheet, or foil of the nickel-iron-based alloy.

In some embodiments, the cathode comprises a material from a group carbon, a metal, and a semiconductor. Nanoparticles of the nickel-iron-based alloy are disposed on the material. In some embodiments, the nanoparticles have dimensions of about 25 nanometers (nm) to 500 nm. In some embodiments, to fabricate the nickel-iron-based alloy nanoparticles, nickel nitrate, iron (III) nitride, and a reducing agent are mixed. In some embodiments, the reducing agent comprises sodium boron hydride. The nickel-iron-based alloy nanoparticles are then deposited on the cathode (i.e., the cathode current collector).

In some embodiments, the nickel-iron-based alloy is a nickel/iron alloy. In some embodiments, the nickel-based alloy is an alloy from a group nickel/iron, nickel/iron/cobalt, and nickel/iron/chromium/molybdenum.

In some embodiments, the nickel iron alloy is about 36% Ni and about 64% Fe. In some embodiments, the nickel iron alloy is 36% Ni and 64% Fe. In some embodiments, the nickel/iron/cobalt alloy is about 29% Ni, about 53% Fe, and about 17% Co. In some embodiments, the nickel/iron/cobalt alloy is 29% Ni, 53% Fc, and 17% Co. In some embodiments, the nickel/iron/chromium/molybdenum alloy is about 58-71% Ni, about 5% Fe, about 20-23% Cr, and about 8-10% Mo. In some embodiments, the nickel/iron/chromium/molybdenum alloy is 58-71% Ni, 5% Fc, 20-23% Cr, and 8-10% Mo. In some embodiments, the anode comprises graphite or platinum.

Returning to FIG. 6, at block 610, with both the cathode and the anode in contact with water, a potential is applied between the cathode and the anode to reduce selenium that is within the water. When a cathodic potential is applied to the cathode, high-valence selenium pollutants are reduced to low-valence selenium, which can precipitate out from the aqueous solution or deposit on the electrode.

In some embodiments, the selenium that is within the water is in the form of Se(IV) oxyanions and Sc (VI) oxyanions. In some embodiments, a potential of −0.45 volts (V) to −0.7 V versus a silver/silver chloride reference electrode is applied between the anode and the cathode. In some embodiments, the water is at a temperature of about 4° C. to 100° C., about 70° C. to 100° C., about 80° C., or at about 90° C. Performing selenium removal from water with the water at an elevated temperature may increase the selenium removal rate.

The following examples are intended to be examples of the embodiments disclosed herein, and are not intended to be limiting.

### Example—Synthesis of Particles of a Nickel-Iron Alloy

Nickel-iron alloys were synthesized via a chemical reduction method using nickel nitrate and iron (III) nitrate as metal precursors and sodium boron hydride as a reducing agent. These alloys can be used to modify the surface of various electrodes, including carbon-based electrodes, metal-based electrodes, and semiconductor electrodes, for the electrochemical reduction of selenium. The nickel-iron alloy materials may be amorphous or crystalline.

### Example—Electrochemical Reduction System

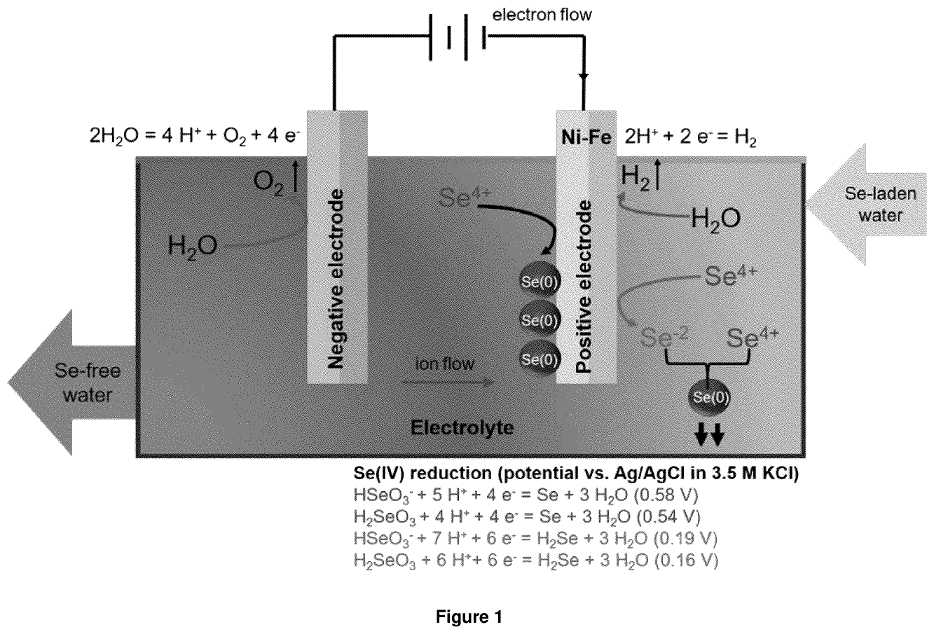

FIG. 1 shows an example of a schematic illustration of an electrochemical reduction system for Se(IV) removal in wastewater using a Ni—Fe electrode. The electrochemical reduction system comprised two electrodes: the cathode (negative electrode) and anode (positive electrode), which are connected to the negative and positive terminals of an external power source. The Ni—Fe electrode is the cathode, and graphite or platinum can be used as the anode. Both electrodes were immersed in the Se-contaminated aqueous electrolyte.

When the system was powered on, electrons flowed from the external power source to the cathode, and reactions took place at the interface between the cathode and electrolyte, converting electrical energy into chemical energy. In Se-contaminated wastewater, the toxic and mobile selenite (Se(IV)) was commonly present as biselenite (HSeO₃⁻) and selenous acid (H₂SeO₃). At a potential of ˜0.5 V, Se(IV) was transformed into stable and insoluble elemental selenium (Se(0)) on the surface of the cathode. Se(IV) can alternatively be converted into soluble Se²⁻ at a potential of ˜0.15 V, which reacts with Se(IV) to generate Se(0). As a result, Se(0) either precipitates on the surface of the cathode or forms insoluble particles within the solution, allowing for easy recovery and separation.

Simultaneously, water (H₂O) molecules underwent a conversion reaction, producing oxygen (O₂) gas on the surface of the anode. A conversion reaction of H₂O molecules may generate hydrogen (H₂) gas, referred to as a hydrogen evolution reaction (HER), on the surface of the cathode. HER competes with selenite reduction reaction and impairs the selenite removal rate, causing high energy consumption. However, the incorporation of iron in a Ni—Fe electrode effectively inhibited the competing HER reaction.

Using Ni—Fe as a cathode resulted in good performance, as it leveraged the combined attributes of Ni and Fe. Their individual contributions are detailed below.

### Example

Currently, the best metal for selenium removal from water is gold. The nickel-iron-based alloys showed a performance better than gold under the same operating conditions. Further, the cost of nickel is much lower than gold. Importantly, the nickel-iron-based alloys have a similar stability as gold in natural aqueous environments (i.e., pH range of about 6 to 8). Table 1 (below) shows a comparison to of performance of gold and a nickel-iron alloy.

TABLE 1

| | | Initial | | | |
|---|---|---|---|---|---|
| | Catalyst | Se(IV) | 6-hour | | Current |
| | Loading | Conc. | Removal | Faraday | Density |
| Electrocatalyst | (μg) | (mM) | Rate | Efficiency | (mA/cm²) |
| Commercial | 68 | 1.0 | 1% | 0.2% | 4.47 |
| Au NPs | | | | | |
| As-synthesized | 68 | 1.0 | 5% | 2% | 2.55 |
| Au—Ag NPs | | | | | |
| As-synthesized | 68 | 1.0 | 25% | 8% | 2.51 |
| FeNi NPs | | | | | |
| Commercial | 7.8*10⁴ | 0.1 | 24% | 3% | 0.14 |
| Au plate | | | | | |
| Commercial | 141 | 12.5 | 12% | 17% | 5.30 |
| Au NPs | | | | | |

### Example—Performance of a Ni—Fe Electrode for Se(IV) Reduction

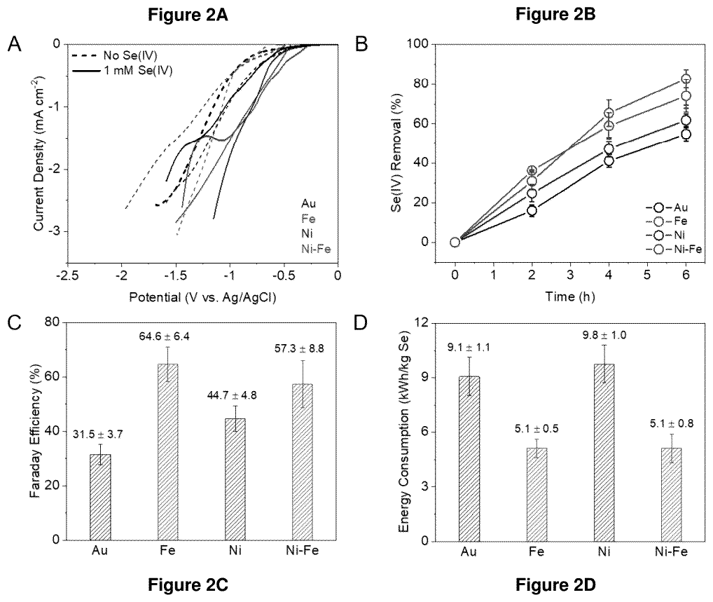

When there was no Se(IV) (dashed lines in FIG. 2A), incorporation of Fe effectively suppressed the competing HER, as evidenced by the low-current density of Ni—Fe, similar to that of the Fe electrode. After adding Se(IV), Ni—Fe electrode demonstrated a high onset potential for Se(IV) reduction to occur (solid lines in FIG. 2A). The Ni—Fe electrode possessed the desired electrocatalytic activity of the Fe electrode for the Se(IV) reduction, resulting in a high Sc (IV) removal rate (FIG. 2B), Faraday efficiency (FIG. 2C), and low specific energy consumption (FIG. 2D).

### Example—Aqueous Stability of a Ni—Fe Electrode

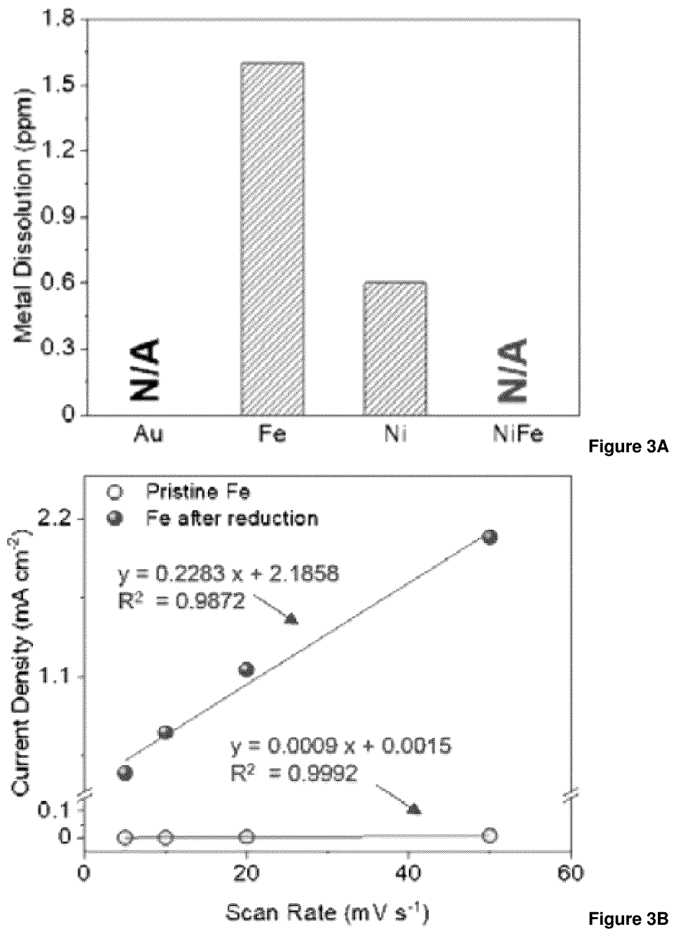

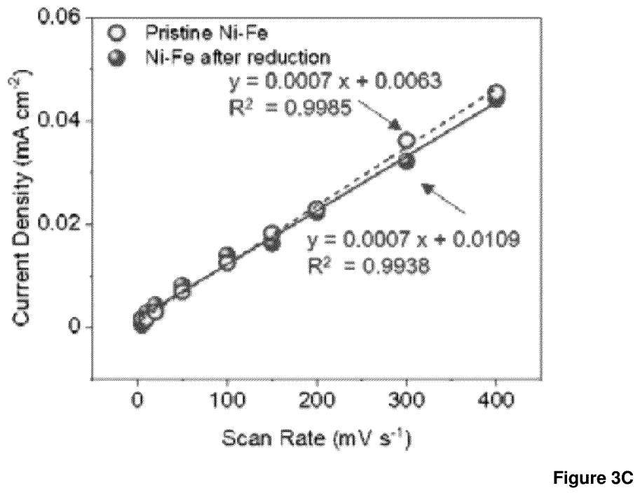

Incorporating Ni with Fe significantly enhanced the aqueous stability of a Fe electrode, as indicated by the metal dissolution observed for the sole Ni and Fe electrodes but none for the Ni—Fe electrode (FIG. 3A). The electrochemical surface area is a reliable indicator of the electrode stability and can be estimated by the change in slope between the current density and the scan rate (FIGS. 3B and 3C). While the Fe electrode showed a significant change before and after electro-reduction, the Ni—Fe electrode exhibited identical slopes (no change), suggesting much improved aqueous stability of Ni—Fe electrode.

### Example—Morphology and Elemental Mapping of a Ni—Fe Electrode

The aqueous stability of a Ni—Fe electrode was further shown by combined scanning electron microscopy/energy dispersive X-ray spectroscopy (SEM/EDS). The results showed remarkable changes in the surface morphology of the sole Fe electrode after electro-reduction but only minimal changes for the Ni—Fe electrode. EDS maps confirmed the deposition of Se(0) after electro-reduction. The disparity in the Fe and O maps for the electrode using Fe alone indicated a partial detachment of the surface layer after electro-reduction. This phenomenon was not observed for the Ni—Fe electrode.

### Example—Performance of a Ni—Fe Electrode for Se(IV) Reduction Under Representative Wastewater Conditions

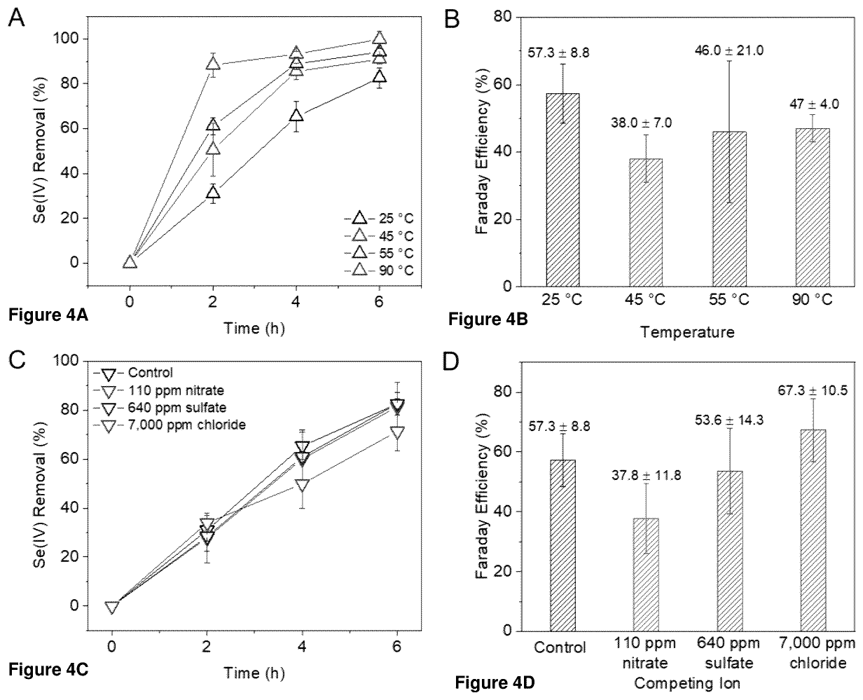

The performance of a Ni—Fe electrode was further enhanced by elevated temperature (FIGS. 4A and 4B) and remains effective in the presence of typical competing anions (FIGS. 4C and 4D). Both are representative of industrial wastewater conditions. Such robust performance underscores the practicability and reliability of a Ni—Fe electrode for treatment of Se-laden wastewater from different sources and/or of different qualities.

### Example—Performance of Ni—Fe-Based Electrodes for Se(IV) Reduction

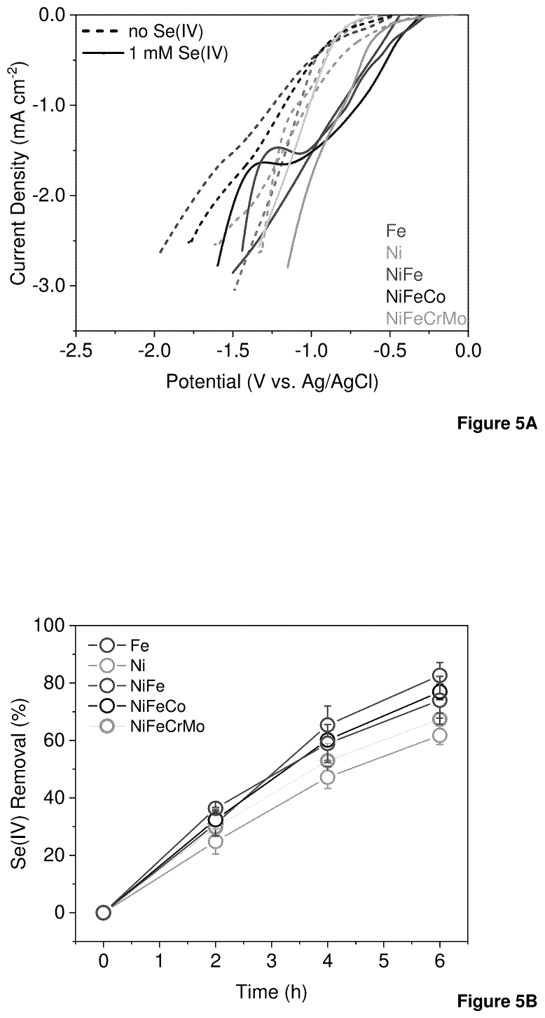

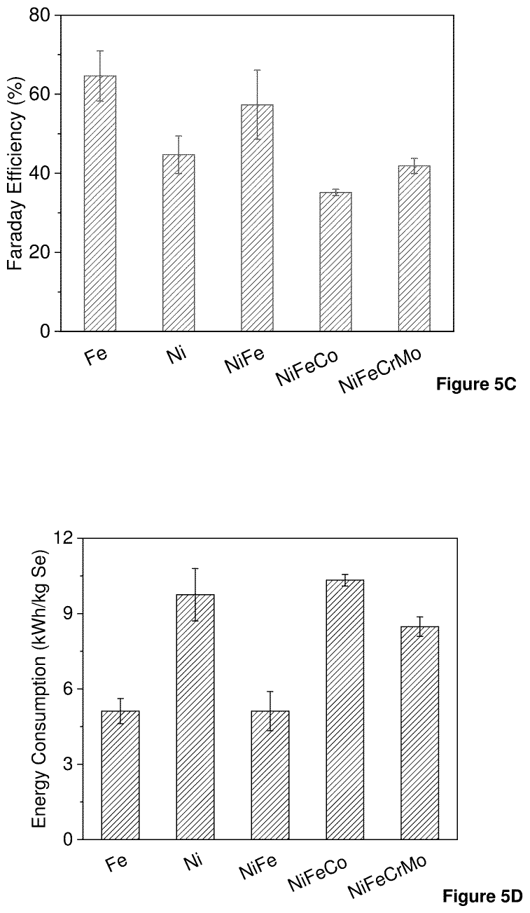

FIGS. 5A-5D show the performance of Ni—Fe-based electrodes for Se(IV) reduction. FIG. 5A shows current density, FIG. 5B shows Se(IV) removal performance, FIG. 5C shows faraday efficiency, and FIG. 5D shows specific energy consumption of various electrodes. Dash and solid lines in FIG. 5A represent the tests without and with Se(IV).

In these experiments, the electrodes had the following compositions: Ni: >99% Ni; Fe: >99% Fe; NiFe: 36% Ni, 64% Fe; NiFeCo: 29% Ni, 53% Fe, 17% Co; and NiFeCrMo: 58-71% Ni, 5% Fe, 20-23% Cr, 8-10% Mo.

### Example—Advantages of a Ni—Fe Electrode

Selenite Removal Rate—Selenite removal rate is quantified by the ratio of the selenite concentration before and after the electro-reduction. A selenite removal rate indicates that selenite is removed more rapidly, thereby reducing the reactor size and footprint for wastewater treatment. A Ni—Fe electrode can achieve a high selenite removal rate of 83% at room temperature—far surpassing that of an Au electrode (55%). Raising the solution temperature to about 90° C. further enhances the selenite removal rate to 99%; such a situation is well suited for high temperature industrial wastewater treatment, where additional heat input would be minimal.

Faraday Efficiency—A high Faraday efficiency signifies that a large portion of the electricity directed into the electrochemical system is effectively utilized for the desired electrochemical reactions, minimizing electricity wasted on the side reactions. A Ni—Fe electrode showed a Faraday efficiency of 78%, notably higher than the 31% and 20% achieved by Au and graphite electrodes, respectively.

Energy Consumption for Selenite Removal—Specific energy consumption for selenite removal refers to the amount of energy needed to remove 1 kilogram (kg) of selenite ions from a solution or wastewater. A lower specific energy consumption implies that a given quantity of selenite can be removed with less energy input, indicating lower energy consumption for treating the same volume of wastewater. A Ni—Fe electrode exhibited a low specific energy consumption of 5.1 kilowatt-hours per kilogram ([kWh]/kg), significantly less than that required by gold (9.1 [kWh]/kg) and graphite (14.1 [kWh]/kg) electrodes.

Aqueous Stability—Aqueous stability refers to the ability of a material to maintain its physical and chemical integrity when exposed to an aqueous environment over time. Electrode material stability is important for sustained performance and safety in wastewater treatment. A Ni—Fe electrode exhibited good stability in aqueous environments, showcasing a synergistic effect that surpasses the stability of pure nickel or iron individually. Electrodes of Ni or Fe alone are susceptible to corrosion and metal dissolution.

Material Cost—Prioritizing affordability and equity in wastewater treatment initiatives is important to improve public health, protect the environment, and advance social justice for all members of society. Material cost accounts for 38% of total capital cost for electrochemical treatment processes, and electrodes represent a substantial portion (33%) of the total material cost. A Ni—Fe electrode offers an advantage in cost-only 0.03% of the cost of an Au electrode. Its affordability is a factor in making this technology viable and economically practical for wastewater treatment applications.

### CONCLUSION

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
providing a device, the device including a cathode and an anode, the cathode comprising a nickel-iron-based alloy; and
with both the cathode and the anode in contact with water, applying a potential between the cathode and the anode to reduce selenium that is within the water.

2. The method of claim 1, wherein the cathode is a nickel-iron-based alloy.

3. The method of claim 1, wherein the cathode comprises a material from a group carbon, a metal, and a semiconductor, and wherein nanoparticles of the nickel-iron-based alloy are disposed on the material.

4. The method of claim 3, wherein the nanoparticles have dimensions of about 25 nanometers to 500 nanometers.

5. The method of claim 1, wherein the nickel-iron-based alloy is a foil.

6. The method of claim 1, wherein the nickel-based alloy is a nickel-iron alloy with about 36% Ni and about 64% Fe.

7. The method of claim 1, wherein the nickel-based alloy is an alloy from a group nickel/iron, nickel/iron/cobalt, and nickel/iron/chromium/molybdenum.

8. The method of claim 1, where in the anode comprises graphite or platinum.

9. The method of claim 1, wherein the selenium that is within the water is in the form of Se(IV) oxyanions and Se(VI) oxyanions.

10. The method of claim 1, wherein the water is at a temperature of about 4° C. to 100° C.
